(19) United States
(12) Patent Application Publication
(10) Pub. No.: US 2023/0379264 A1
(43) Pub. Date: Nov. 23, 2023

(54) METHOD AND APPARATUS FOR ON-TIME PACKET FORWARDING BASED ON RESOURCE

(71) Applicant: Electronics and Telecommunications Research Institute, Daejeon (KR)

(72) Inventors: Yeoncheol RYOO, Daejeon (KR); Taesik CHEUNG, Daejeon (KR)

(73) Assignee: Electronics and Telecommunications Research Institute, Daejeon (KR)

(21) Appl. No.: 18/315,001

(22) Filed: May 10, 2023

(30) Foreign Application Priority Data
May 18, 2022 (KR) 10-2022-0060589
Mar. 10, 2023 (KR) 10-2023-0031708

(51) Int. Cl. H04L 47/56; H04L 45/302; H04L 43/0852

(52) U.S. Cl. CPC H04L 47/56; H04L 45/302; H04L 43/0852

(57) ABSTRACT

The present disclosure relates generally to a communication system, and more particularly, to a method for time-deterministic packet forwarding that guarantees a maximum and minimum latency requirement of a service, the method including: receiving latency information of links and nodes on a path, and buffer resource information of the nodes; calculating, on the basis of the buffer resource information of the last node, local latency budgets that the other nodes need to guarantee; performing control so that the nodes transmit a packet on the basis of the local latency budgets; and finally guaranteeing, by the last node, a residual latency budget remaining after the nodes transmit the packet within the local latency budgets.

### CROSS REFERENCE TO RELATED APPLICATION

The present application claims priority to Korean Patent Application No. 10-2022-0060589, filed May 18, 2022 and Korean Patent Application No. 10-2023-0031708, filed Mar. 10, 2023, the entire contents of which is incorporated herein for all purposes by this reference.

### BACKGROUND OF THE INVENTION

### Field of the Invention

The present disclosure relates to a method for time-deterministic packet forwarding that guarantees latency time that it takes to forward traffic over a network, in a packet network such as Ethernet, IP, MPLS, etc., and to a method and an apparatus for packet forwarding that guarantees the maximum and minimum latency time on the basis of clear resource information.

### Description of the Related Art

Recently, in the network technology field, an industry convergence network technology capable of simultaneously accommodating time-sensitive traffic, such as general management traffic, real-time remote control traffic, etc., in a single network has undergone much research and many developments. In Industry 4.0 application, for industrial automation, distributed manufacturing, etc. through remote control of robots, machines, etc., control and remote measurement data must be forwarded on targeted deterministic time.

In particular, actuators of sensors, robots, machines, etc. and process logic controllers (PLCs) for controlling the same in the industrial area exchange measurement data and control data at regular time intervals so that a process is precisely controlled in the form of closed-loop control. In this application, even if data arrives early, the data must wait until a determined processing time. To this end, each end device must have a buffer. If data arrives late beyond the determined processing time, a process does not operate as planned, so the period of closed-loop control must be increased according to the estimated maximum latency time. This eventually causes a problem of lowering the precision of control. In addition, there is another problem that the larger a difference between the maximum latency and the minimum latency, the larger the size of the buffer of each end device must be.

In order to satisfy requirements of the application, it is no longer sufficient to simply optimize the network and minimize latency as in a conventional method, and it should be possible to guarantee the maximum and minimum latency time to guarantee quantified target times, such as latency time required for traffic to be forwarded to an end and jitter representing latency deviation between packets.

The foregoing is intended merely to aid in the understanding of the background of the present disclosure, and is not intended to mean that the present disclosure falls within the purview of the related art that is already known to those skilled in the art.

### SUMMARY OF THE INVENTION

On the basis of the above description, the present disclosure is directed to providing an apparatus and a method for on-time packet forwarding based on a resource, the apparatus and the method enabling the total latency time, which it takes to forward service traffic over a network, to satisfy a quantified maximum and minimum latency target time required by a service.

According to various embodiments of the present disclosure, there is provided a method for time-deterministic packet forwarding that guarantees a maximum and minimum latency requirement of a service, the method including: receiving latency information of links and nodes on a path, and buffer resource information of the nodes; calculating, on the basis of the buffer resource information of the last node, local latency budgets that the other nodes need to guarantee; performing control so that the nodes transmit a packet on the basis of the local latency budgets;

and performing control so that finally, the last node guarantees a residual latency budget remaining after the nodes transmit the packet within the local latency budgets.

According to an embodiment, the buffer resource information of the last node may be determined on the basis of a buffer size allocated to the service and attributes of the service.

According to an embodiment, the performing of control so that the nodes transmit the packet on the basis of the local latency budgets may include setting clear upper and lower bounds of the local latency budget that each of the nodes needs to guarantee.

According to an embodiment, the performing of control so that the nodes transmit the packet on the basis of the local latency budgets may include: collecting the buffer resource information of all the nodes; and calculating the local latency budget of each of the nodes that does not exceed latency time providable on the basis of a buffer resource of each node.

According to an embodiment, the local latency budgets may be determined on the basis of total network latency and residual latency time obtained by subtracting latency guaranteeable by the last node so that a service latency requirement is guaranteed.

According to an embodiment, in order for the last node to guarantee the residual latency budget finally, the method may include: forwarding, to the last node, actual latency information consumed by each of the nodes when the nodes transmit the packet within upper bounds and lower bounds of the local latency budgets; identifying the residual latency budget on the basis of the actual latency information forwarded from the previous nodes; and setting the identified residual latency budget as a local latency budget of the last node.

According to an embodiment, when an upper bound of the residual latency is greater than maximum latency providable on the basis of a buffer resource of the last node, it may be determined that an upper bound of the local latency budget of the last node is the maximum latency providable by the last node.

According to an embodiment, the attributes of the service may include information on a packet forwarding period, the number of packets forwarded within the period, and a packet size.

According to various embodiments of the present disclosure, there is provided an apparatus for time-deterministic packet forwarding that guarantees a maximum and minimum latency requirement of a service, the apparatus including a transceiver; and a control part operably connected to the transceiver, wherein the control part is configured to receive latency information of links and nodes on a path, and buffer resource information of the nodes; calculate, on the basis of the buffer resource information of the last node, local latency budgets that the other nodes need to guarantee; perform control so that the nodes transmit a packet on the basis of the local latency budgets; and perform control so that finally, the last node guarantees a residual latency budget remaining after the nodes transmit the packet within the local latency budgets.

According to various embodiments of the present disclosure, there is provided an SDN controller for time-deterministic packet forwarding that guarantees a maximum and minimum latency requirement of a service, the SDN controller including: a transceiver; and a control part operably connected to the transceiver, wherein the control part is configured to receive latency information of links and nodes on a path, and buffer resource information of the nodes; calculate, on the basis of the buffer resource information of the last node, local latency budgets that the other nodes need to guarantee; perform control so that the nodes transmit a packet on the basis of the local latency budgets; and perform control so that finally, the last node guarantees a residual latency budget remaining after the nodes transmit the packet within the local latency budgets.

The apparatus and the method according to various embodiments of the present disclosure guarantee on-time performance required by a service by each of the nodes performing forwarding according to clear local latency budgets that can satisfy a service latency requirement on the basis of definitive resource information. Simultaneously, the apparatus and the method enable packet scheduling at the intermediate nodes with margins greater than the service latency requirement, thereby strictly complying with upper bound and lower bound requirements of the service and reducing packet scheduling loads of the nodes.

In addition, according to the apparatus and the method according to various embodiments of the present disclosure, when an upper bound and a lower bound of a service latency requirement differ a little or are even the same, the deviation between an upper bound and a lower bound of the local latency budget of each node is made as large as possible, thereby reducing the packet scheduling load of each node.

Effects that may be obtained from the present disclosure will not be limited to only the above described effects. In addition, other effects which are not described herein will become apparent to those skilled in the art from the following description.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 shows a problem of a CQF method, which is a conventional technology according to various embodiments of the present disclosure;

FIG. 2 shows a problem of an SR-TSN method, which is a conventional technology according to various embodiments of the present disclosure;

FIG. 3 shows a problem of an LBF method, which is a conventional technology according to various embodiments of the present disclosure;

FIG. 4 shows a method for on-time forwarding based on a resource according to an embodiment of the present disclosure;

FIG. 5 shows an operation of a method for on-time forwarding based on a resource according to various embodiments of the present disclosure;

FIG. 6 shows an operation of extending a method for on-time forwarding based on a resource, according to various embodiments of the present disclosure;

FIG. 7 shows an operation method of an SDN controller according to an embodiment of the present disclosure; and

FIG. 8 shows a configuration diagram of an SDN controller in a communication system, according to various embodiments of the present disclosure.

### DETAILED DESCRIPTION OF THE INVENTION

The terms used in the present disclosure are merely used to describe a particular embodiment, and are not intended to limit the scope of another embodiment. An expression used in the singular encompasses the expression of the plural, unless it has a clearly different meaning in the context. All the terms including technical and scientific terms used herein have the same meaning as commonly understood by those skilled in the art to which the present disclosure belongs. Among the terms used in the present disclosure, the terms defined in a general dictionary may be interpreted to have the meanings the same as or similar to the contextual meanings in the relevant art, and are not to be interpreted to have ideal or excessively formal meanings unless explicitly defined in the present disclosure. In some cases, even the terms defined in the present disclosure should not be interpreted to exclude the embodiments of the present disclosure.

In various embodiments of the present disclosure to be described below, a hardware approach will be described as an example. However, the various embodiments of the present disclosure include a technology using both hardware and software, so the various embodiments of the present disclosure do not exclude a software-based approach.

Hereinafter, the present disclosure relates to a method and an apparatus for on-time packet forwarding based on a resource. Specifically, in the present disclosure, a time-deterministic packet forwarding technology will be described, wherein the technology enables the total latency time that it takes to forward service traffic over a network, to satisfy a latency time requirement of a service, in a packet network such as Ethernet, IP, MPLS, etc.

The terms referring to signals, the terms referring to channels, the terms referring to control information, the terms referring to network entities, the terms referring to elements of an apparatus, and the like used in the description below are only examples for the convenience of description. Accordingly, the present disclosure is not limited to the terms described below, and the terms may be replaced by other terms having the same technical meanings.

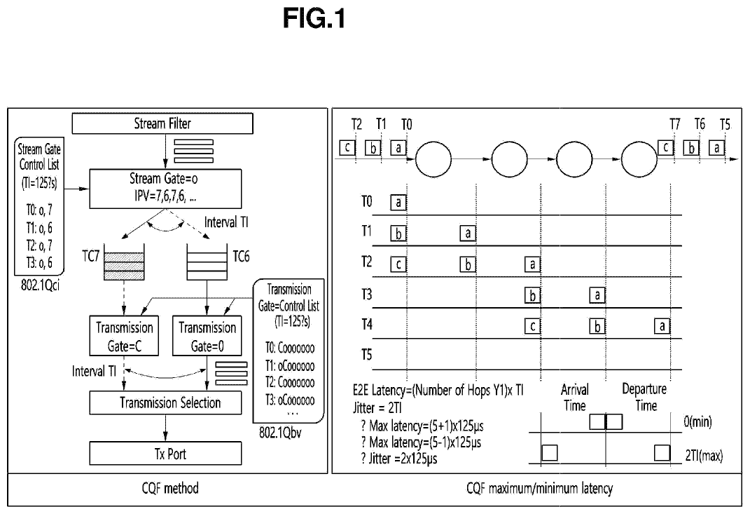

As related technologies, which are related to the present disclosure, for guaranteeing a quantified target time, there are time-deterministic forwarding technologies defined in IEEE 802.1 time-sensitive networking (TSN) and deterministic networking (DetNet) of the IETF. As a method defined in the TSN, there is a time-aware shaper (TAS), which controls the output time of a queue on the basis of time synchronization, and cyclic queuing and forwarding (CQF) using the TAS. However, this method has a problem that a time interval (TI) determined according to traffic characteristics of a service determines maximum latency and latency deviation, so the end-to-end latency time of a network cannot be controlled as desired. For example, a problem of a CQF method will be described in detail with reference to FIG. 1.

FIG. 1 shows a problem of a CQF method, which is a conventional technology according to various embodiments of the present disclosure.

Referring to FIG. 1, in the CQF method, a time interval value determined according to traffic attributes and the number of hops on a path determine maximum latency and latency deviation. For example, when the TI is 125 μs, each of the nodes alternates two queues at intervals of 125 μs to store and transmit traffic, so the end-to-end maximum latency of the traffic is (the number of nodes+1)×125 μs, the minimum latency is (the number of nodes−1)×125 μs, and the jitter is 250 μs (2×125 μs). However, these values are determined by the TI value determined according to the attributes of the traffic, so are irrelevant the maximum latency and the latency deviation required by a service. Therefore, the CQF method has limitations in satisfying a latency requirement of a service. A tagged CQF (T-CQF) method, which has been discussed in the DetNet to improve the CQF method of the TSN to operate in a wide area network, also has the same limitations.

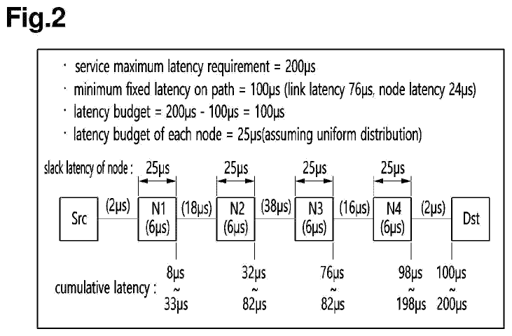

As another method that has been discussed in the DetNet, there is an SR-TSN method that results from extending a segment routing (SR) technology and specifies a deadline by which each node must transmit a packet. However, this method may satisfy the maximum latency requirement of a service, but does not guarantee on-time forwarding. For example, a problem of an SR-TSN method will be described in detail with reference to FIG. 2.

FIG. 2 shows a problem of an SR-TSN method, which is a conventional technology according to various embodiments of the present disclosure.

Referring to FIG. 2, in the SR-TSN, the latency budget obtained by subtracting the minimum fixed latency on a path from the maximum latency a user requires is appropriately distributed to nodes and each of the nodes forwards a packet within the given budget, so when congestion does not occur in the network, a packet is forwarded with the minimum latency, or even if congestion occurs, the maximum latency is guaranteed. Therefore, the on-time performance that the method can guarantee is determined by the maximum latency requirement of a service and the minimum fixed latency on a path as shown in the example of FIG. 2, so the on-time performance cannot be guaranteed as the service requires.

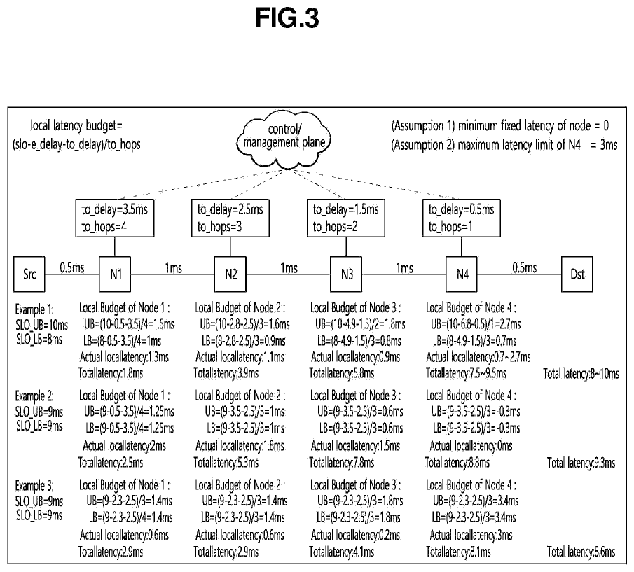

A recently announced latency-based forwarding method can forward traffic at a point in time exactly right for a service requirement in principle. This method calculates traffic transmission time for guaranteeing the maximum and minimum latency time, on the basis of a service latency requirement, the number of remaining nodes from each node to the end, the estimated time required for packet transmission, and the elapsed time so far. In this method, the service requirement can be satisfied even if nodes excluding the last node responsible for on-time forwarding output a packet with latency time different from calculated latency budget. However, the method does not know the resource status of the last node, so operation should be performed within the calculated latency budget in reality. This limitation causes a problem that the smaller a latency deviation requirement of a service, the much smaller budget each node must operate within. For example, a problem of an LBF method will be described in detail with reference to FIG. 3.

FIG. 3 shows a problem of an LBF method, which is a conventional technology according to various embodiments of the present disclosure.

Referring to FIG. 3, in order to provide on-time forwarding, the LBF calculates local latency budget of each node on the basis of the maximum and minimum latency requirement (SLO_UB, SLO_LB) of a service, the elapsed time so far (e_delay), the number of nodes remaining to a destination (to_hops), and the minimum latency time (to_delay) estimated to take on the remaining path. As shown in Example 1 of FIG. 3, when all nodes forward a packet within calculated upper bounds (UBs) and lower bounds (LBs) of the local latency, the latency time to the destination can satisfy a service requirement. However, as shown in Example 2 and Example 3 of FIG. 3, when the actual latency time of each node is over the local latency budget, the service requirement cannot be satisfied. As shown in Example 2, when each of the nodes N1, N2, and N3 forwards a packet with latency greater than the calculated latency budget, the total latency time is greater than the maximum latency requirement of the service even though the node N4 forwards a packet without latency.

In addition, as shown in Example 3, when each of the nodes N1, N2, and N3 forwards a packet with latency less than the calculated latency budget, the calculated latency budget (3.4 ms) of the node N4 is over the maximum latency limit (3 ms) and the total latency time is less than the minimum latency requirement of the service. Therefore, in the LBF method, in principle a service latency requirement can be satisfied even if each of the nodes overspends the calculated budget, but it is impossible to know an allowable budget-exceeding range, so each of the nodes must stick to the calculated budget exactly in reality.

As in Examples 2 and 3, due to this limitation, when the upper bound and the lower bound of the service latency requirement are the same, all intermediate nodes must forward a packet at an exact point in time without margin, so the packet scheduling load increases unnecessarily at all the nodes.

The present disclosure is to overcome the limitation in on-time forwarding performance, which is the problem of the above-described conventional technologies, and in particular, to solve the problem of the latency-based forwarding method in the related art. Specifically, in solving the problem of the latency-based time-deterministic forwarding technology in the related art, by using resource information of the last node or nodes on a path, other nodes calculate local latency budgets.

Various types of information, for example, a service latency requirement for nodes in a network, the number of nodes on a path, the minimum fixed latency of each of the nodes and links, buffer resource information of the nodes, etc., required to perform a method for on-time forwarding based on a resource according to the present disclosure may be provided in various ways. The information may be collected through an SDN-based centralized control/management controller, or a signaling protocol of a distributed method. Information required for on-time forwarding identified on the basis of the collected resource and latency information may be provided in packet headers through packet formats of various methods, and each node may update required information after required processing. Alternatively, the information may be provided through packet overhead on a data plane, such as segment routing beneficial in terms of scalability of a network. Hereinafter, an embodiment of the present disclosure will be described assuming that pieces of information required for operation are provided in a packet header and each node updates related information after packet processing for on-time forwarding.

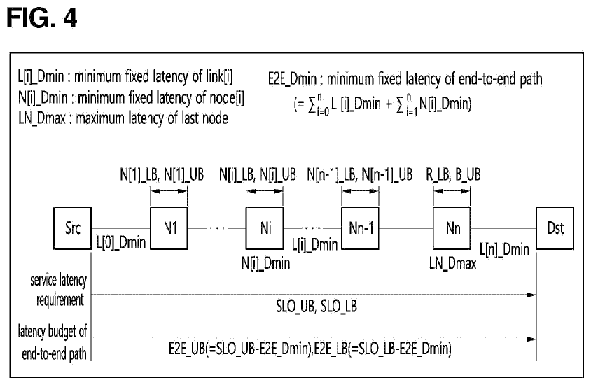

FIG. 4 shows a method for on-time forwarding based on a resource according to an embodiment of the present disclosure.

Referring to FIG. 4, the following parameters are defined.
SLO_LB: the lower bound of a user latency requirement
SLO_UB: the upper bound of a user latency requirement
L[i]_Dmin: the minimum fixed latency of link[i]
N[i]_Dmin: the minimum fixed latency of node[i]
E2E_Dmin: the sum of minimum fixed latencies of an end-to-end path (ΣL_Dmin+ΣN_Dmin)
E2E_LB: the lower bound of the latency budget of an end-to-end path (SLO_LB−E2E_Dmin)
E2E_UB: the upper bound of the latency budget of an end-to-end path (SLO_UB−E2E_Dmin)
N_Dmax: the maximum latency providable by a buffer resource of a node
LN_Dmax: the maximum latency providable by a buffer resource of the last node
N[i]_LB: the lower bound of the latency budget of node[i] (1≤i≤n−1)
N[i]_UB: the upper bound of the latency budget of node[i] (1≤i≤n−1)
R_LB: the lower bound of the residual latency budget (the lower bound of the latency budget of the last node)
R_UB: the upper bound of the residual latency budget (the upper bound of the latency budget of the last node)

Referring to FIG. 4, a series of packets requiring a guarantee of both the minimum (SLO_LB) and maximum (SLO_UB) latency times is defined as an on-time flow, and E2E_Dmin, N_Dmax of each of the nodes, and LN_Dmax providable by the last node may be collected through an SDN controller or a protocol. E2E_Dmin may be the sum of minimum fixed latencies of all links and nodes that exist on a path between a transmitting end and a receiving end.

Link minimum latency may be calculated by comparing packet transmission and reception times between nodes synchronized in time through the IEEE 1588 time synchronization method, or may be measured through a separate latency measurement method.

Node minimum latency is fixed latency required for all packet processing, such as packet encoding/decoding, packet overhead lookup, etc., except queuing latency, and may be a value determined according to the implementation of a node.

N_Dmax and LN_Dmax mean the maximum buffering times of an intermediate node and the last node, and may be maximum latency times calculated on the basis of the attributes (bandwidth, packet size, etc.) of a service flow and buffer resources, excluding the minimum fixed latency of a node.

The method for on-time forwarding according to an embodiment of the present disclosure may use the collected E2E_Dmin, N_Dmax, and LN_Dmax and the SLO_LB and SLO_UB required by a user to determine the lower bound (N[i]_LB) and the upper bound (N[i]_LB) of the latency budget that each of the nodes should guarantee, and the lower bound (R_LB) and the upper bound (R_UB) of the latency budget that the last node should guarantee.

According to an embodiment, these are calculated as in Equations 1 to 4.

N[i]_LB=(E2E_LB−LN_Dmax)/n−1 [Equation 1]

N[i]_UB=E2E_UB/n−1 [Equation 2]

R_LB=E2E_LB−Σᵢ₌₁ⁿ⁻¹N[i]_{D} [Equation 3]

R_UB=E2E_UB−Σᵢ₌₁ⁿ⁻¹N[i]_D [Equation 4]

Herein, N[i]_D denotes the actual latency time of the i-th node.

Equations 1 and 2 may be the simplest calculation example in which the latency budget of the last nodes is equally distributed to nodes. In addition, according to an embodiment, the N[i]_LB and N[i]_UB may mean values less than N_Dmax.

According to another embodiment, considering N_Dmax of each node, the latency budget may be unequally distributed so that the total of N[i]_LB is E2E_LB−LN_Dmax and the total of N[i]_UB is E2E_UB.

According to an embodiment, a method of providing an on-time forwarding function on the basis of the calculated N[i]_LB, N[i]_UB, R_LB, and R_UB is as follows.

The nodes (N[i], 1≤i≤n−1) excluding the last node may perform QoS operation so that a packet is forwarded within the local latency budget, that is, the lower bound (N[i]_LB) and the upper bound (N[i]_UB) of the local latency budget, calculated on the basis of latency and buffer information and forwarded through the centralized controller or signaling protocol. Depending on a result of processing the packet, the actually elapsed latency time (N[i]_D) may be forwarded in a packet.

According to an embodiment, as a method of forwarding the actual latency time of a node, initially, the residual latency budget (R_UB, R_LB) in a packet header may be specified to be a value equal to the end-to-end path latency budget (E2E_UB, E2E_LB) and when each of the nodes forwards a packet, update is performed with a value obtained by subtracting the actual latency time, so that residual latency budget information in the packet header entering the last node may be the local latency budget of the last node. The last node may perform the QoS operation so that a packet is forwarded within the lower bound (R_LB) and the upper bound (R_UB) of the residual latency budget. When the upper bound of the local latency budget of the last node is greater than the maximum latency (LN_Dmax) providable by the last node buffer, LN_Dmax may be the latency upper bound of the last node.

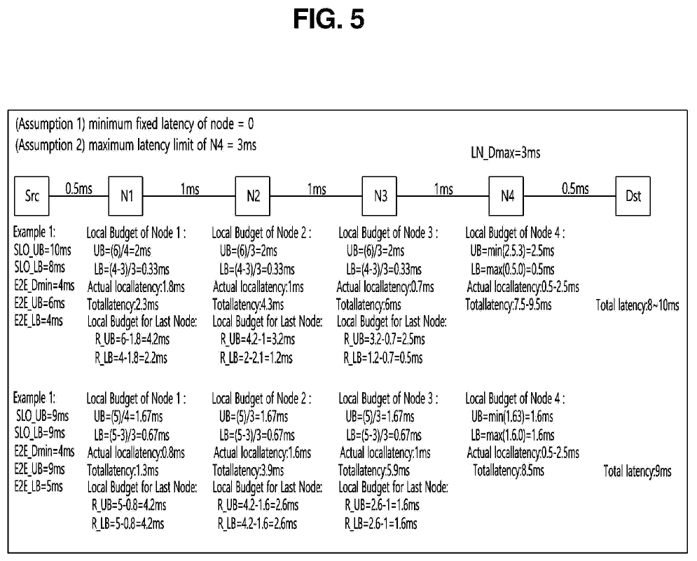

FIG. 5 shows an operation of a method for on-time forwarding based on a resource according to various embodiments of the present disclosure. It is assumed that the network configuration and service requirement in FIG. 5 are the same as those in FIG. 3 in order to show a difference between the present disclosure and the LBF method in the related art.

Referring to FIG. 5, Example 1 of FIG. 5 shows a case in which the upper bound and the lower bound of the service latency requirement differ. It is found that all nodes forward a packet within the calculated local latency budgets and the total latency time thus satisfies the latency requirement of the service.

According to an embodiment of the present disclosure, Example 2 of FIG. 5 shows improved characteristics over the LBF method in the related art. Even when the upper bound and the lower bound of the service latency requirement are the same, according to the present disclosure, the local latency budget has the upper bound of 1.67 ms and the lower bound of 0.67 ms, so the QoS operation may be performed with the margin of 1 ms. Conversely, according to the LBF method in the related art, the upper bound and the lower bound of the local latency budget have the same value as in Examples 2 and 3 of FIG. 3. Therefore, in the LBF method in the related art, unless there is separate additional information, all nodes must perform the QoS operation so that a packet is forwarded at an exact point in time.

According to an embodiment, in the method for on-time forwarding based on a resource according to the present disclosure, the defined residual latency budget (R_UB, R_LB) is forwarded as a value obtained by subtracting the actual latency time of the last node when the last node forwards a packet to the destination (receiving end), so may be used as data required for the receiving end to internally process a service in an application.

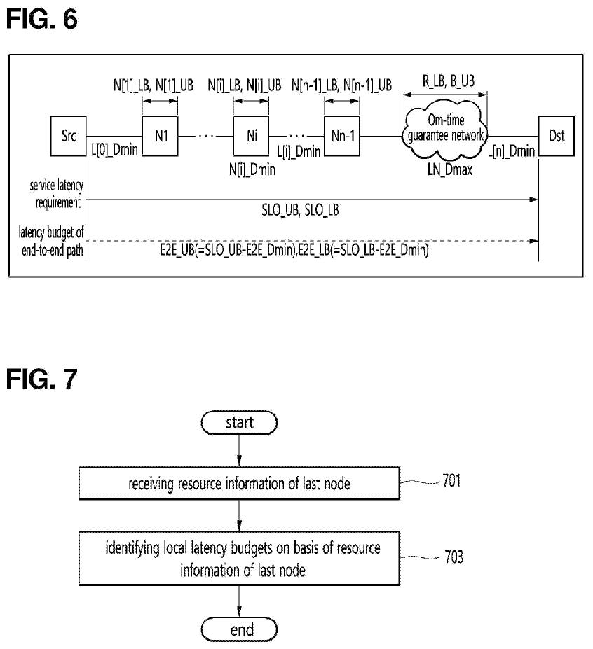

FIG. 6 shows an operation of extending a method for on-time forwarding based on a resource, according to various embodiments of the present disclosure. Specifically, the last node shown in FIG. 4 in the method for on-time forwarding based on a resource according to the present disclosure may be extended to a network shown in FIG. 6. Herein, the network may be any network capable of forwarding a packet within a given latency budget as the last node of FIG. 4 does, and making the maximum latency time providable by the network deterministic.

FIG. 7 shows an operation method of an SDN controller according to an embodiment of the present disclosure.

Referring to FIG. 7, the SDN controller may receive resource information of the last node from the last node in step 701.

According to an embodiment, the resource information of the last node may be determined on the basis of a buffer size allocated to a service and attributes of the service. Local latency budgets may be determined on the basis of a latency requirement of the service and the maximum latency time of the last node.

According to an embodiment, the attributes of the service may include information on a bandwidth or the packet size.

According to an embodiment, the last node may be a network capable of forwarding a packet within a given latency budget and making the maximum latency time deterministic.

According to an embodiment, the local latency budgets may be identified on the basis of the service latency requirement and the total time latency budget elapsed on the network.

The SDN controller may identify the local latency budgets on the basis of the resource information of the last node in step 703.

According to an embodiment, when the local latency budget of the last node is greater than the maximum latency providable by the last node, the maximum latency providable by the last node may be determined as the latency upper bound of the last node.

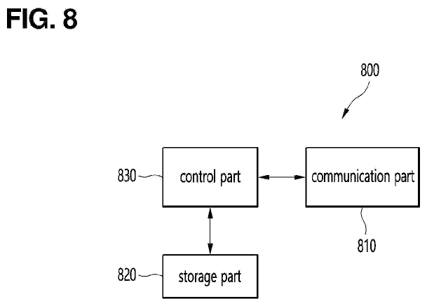

FIG. 8 shows a configuration diagram of an SDN controller in a communication system, according to various embodiments of the present disclosure. The configuration illustrated in FIG. 3 may be understood as a configuration of an SDN controller 800. The terms “˜part”, “˜unit”, and the like used below mean a unit for processing at least one function or operation, and may be implemented by hardware, software, or a combination of hardware and software.

Referring to FIG. 8, the SDN controller 800 may include a communication part 810, a storage part 820, and a control part 830.

The communication part 810 may perform functions for transmitting and receiving signals through various communication methods including wired and wireless communications.

In addition, the communication part 810 may include multiple transmission and reception paths. In terms of hardware, the communication part 810 may be a digital circuit and an analog circuit (for example, a radio frequency integrated circuit (RFIC)). Herein, the digital circuit and the analog circuit may be realized as one package.

All or part of the communication part 810 may be referred to as a “transmitter”, “receiver” or “transceiver”. In addition, in the following description, the term wired or wireless transmission and reception may be used to mean that the communication part 810 performs the above-described processing.

The storage part 820 may store therein data, such as default programs, application programs, setting information, etc., for the operation of the SDN controller. The storage part 820 may be a volatile memory, a non-volatile memory, or a combination of a volatile memory and a non-volatile memory. In addition, the storage part 820 may provide the stored data according to a request of the control part 830.

The control part 830 may control overall operations of the SDN controller. For example, the control part 830 may transmit and receive signals through the communication part 810. In addition, the control part 830 may record data on the storage part 820 and read the data. The control part 830 may perform functions of a protocol stack that communication standards require. To this end, the control part 830 may include at least one processor or microprocessor, or may be part of a processor. In addition, part of the communication part 810 and the control part 830 may be referred to as a communication processor (CP).

According to various embodiments, the control part 830 may perform control so that the operations shown in FIGS. 4 to 7 are performed.

According to various embodiments of the present disclosure, a packet forwarding method wherein a network satisfies a latency requirement of a service may perform resource-based on-time packet forwarding in which resource information of the last node on a path is used so that the other nodes calculate local latency budgets.

According to an embodiment, in the resource-based on-time packet forwarding, buffer resource information of the last node is the maximum latency time determined according to a buffer size allocated to the service and attributes of the service.

According to an embodiment, in the resource-based on-time packet forwarding, the local latency budgets are calculated on the basis of the latency requirement of the service and the maximum latency time of the last node.

According to an embodiment, in the resource-based on-time packet forwarding, the last node may be a network capable of forwarding a packet within a given latency budget and making the maximum latency time deterministic.

According to various embodiments of the present disclosure, a packet forwarding method wherein a network satisfies a latency requirement of a service may provide a destination (receiving end) with the latency requirement of the service and the residual latency budget obtained by subtracting the total latency time elapsed on the network.

According to various embodiments of the present disclosure, the present disclosure may include: collecting latency information of all links and nodes on a path and buffer resource information of the nodes through various methods such as a SDN (software define network) controller-based centralized method or a protocol-based distributed method; calculating, on the basis of the collected latency information of the links and the nodes, the total end-to-end maximum and minimum latency budget to satisfy a service requirement; calculating, on the basis of the buffer resource information of the last node, the maximum and minimum local latency budgets that the previous nodes need to guarantee; performing control so that the nodes transmit a packet on the basis of the local latency budgets; and finally consuming, by the final node, the residual budget obtained by subtracting the sum of the local latency budgets consumed by the previous nodes from the total maximum and minimum latency budget.

According to various embodiments of the present disclosure, as a method of determining the residual budget that the final node needs to guarantee, the present disclosure may use a method of calculating the required time until the arrival time by forwarding the forwarding time of a packet while all network nodes are synchronized in time, and pieces of local budget information consumed by respective nodes may be added and a result is forwarded or pieces of local budget information consumed by respective nodes may be subtracted from the total local budget and a result is forwarded in a packet forwarded in a time-asynchronous network.

According to various embodiments of the present disclosure, the SDN controller-based centralized method may be in charge of a function that is set such that when a service is requested while the controller has collected information of all network nodes, each of the nodes transmits a packet according to the budget calculated on the basis of the information collected by the controller. The protocol-based distributed method may be in charge of a function that is set such that when a service is requested through a protocol, each of the nodes forwards latency and resource information to the final node and the final node transmits a packet according to the local budget calculated on the basis of the information collected along with the request for the service.

Methods according to the embodiments described in the claims of the present disclosure or in the specification may be implemented in the form of hardware, software, or a combination of hardware and software.

In the case of software implementation, a computer-readable storage medium in which at least one program (software module) is stored may be provided. The at least one program stored in the computer-readable storage medium is configured to be executable by at least one processor in an electronic device. The at least one program includes instructions for the electronic device to execute the methods according to the embodiments described in the claims of the present disclosure or the specification.

The program (software module or software) may be stored in non-volatile memory including random-access memory and flash memory, read-only memory (ROM), electrically erasable programmable read-only memory (EEPROM), a magnetic disc storage device, a compact disc-ROM (CD-ROM), digital versatile discs (DVDs), optical storage devices of other types, or a magnetic cassette. Alternatively, the program may be stored in a memory composed of a combination of some or all of these memories. In addition, a plurality of such memories may be included.

In addition, the program may be stored in an attachable storage device that is accessible through a communication network, such as the Internet, Intranet, a local area network (LAN), a wide area network (WAN), or a storage area network (SAN), or a combination thereof. The storage device may be connected through an external port to an apparatus performing an embodiment of the present disclosure. In addition, a separate storage device on the communication network may be connected to the apparatus performing an embodiment of the present disclosure.

In the above-described detailed embodiments of the disclosure, an elements included in the disclosure is expressed in the singular or the plural according to a presented detailed embodiment. However, the singular form or plural form is selected suitable for the presented situation for convenience of description, and the various embodiments of the disclosure are not limited to a single element or multiple elements thereof. Further, either multiple elements expressed in the description may be configured into a single element or a single element in the description may be configured into multiple elements.

Although the specific embodiments have been described in the detailed description of the present disclosure, various modifications and changes may be made thereto without departing from the scope of the present disclosure. Therefore, the scope of the present disclosure should not be defined as being limited to the embodiments, but should be defined by the appended claims and equivalents thereof.

What is claimed is:

1. A method for time-deterministic packet forwarding that guarantees a maximum and minimum latency requirement of a service, the method comprising:
receiving latency information of links and nodes on a path, and buffer resource information of the nodes;
calculating, on the basis of the buffer resource information of the last node, local latency budgets that the other nodes need to guarantee;
performing control so that the nodes transmit a packet on the basis of the local latency budgets; and
performing control so that finally, the last node guarantees a residual latency budget remaining after the nodes transmit the packet within the local latency budgets.

2. The method of claim 1, wherein the buffer resource information of the last node is determined on the basis of a buffer size allocated to the service and attributes of the service.

3. The method of claim 1, wherein the performing of control so that the nodes transmit the packet on the basis of the local latency budgets comprises
setting clear upper and lower bounds of the local latency budget that each of the nodes needs to guarantee.

4. The method of claim 3, wherein the performing of control so that the nodes transmit the packet on the basis of the local latency budgets comprises:
collecting the buffer resource information of all the nodes; and
calculating the local latency budget of each of the nodes that does not exceed latency time providable on the basis of a buffer resource of each node.

5. The method of claim 4, wherein the local latency budgets are determined on the basis of total network latency and residual latency time obtained by subtracting latency guaranteeable by the last node so that a service latency requirement is guaranteed.

6. The method of claim 1, wherein the performing of control so that finally, the last node guarantees the residual latency budget comprises:
forwarding, to the last node, actual latency information consumed by each of the nodes when the nodes transmit the packet within upper bounds and lower bounds of the local latency budgets;
identifying the residual latency budget on the basis of the actual latency information forwarded from the previous nodes; and
setting the identified residual latency budget as a local latency budget of the last node.

7. The method of claim 6, wherein when an upper bound of the residual latency budget is greater than maximum latency providable on the basis of a buffer resource of the last node, it is determined that an upper bound of the local latency budget of the last node is the maximum latency providable by the last node.

8. The method of claim 2, wherein the attributes of the service include information on a packet forwarding period, the number of packets forwarded within the period, and a packet size.

9. An apparatus for time-deterministic packet forwarding that guarantees a maximum and minimum latency requirement of a service, the apparatus comprising:
a transceiver; and
a control part operably connected to the transceiver,
wherein the control part is configured to
receive latency information of links and nodes on a path, and buffer resource information of the nodes;
calculate, on the basis of the buffer resource information of the last node, local latency budgets that the other nodes need to guarantee;
perform control so that the nodes transmit a packet on the basis of the local latency budgets; and
perform control so that finally, the last node guarantees a residual latency budget remaining after the nodes transmit the packet within the local latency budgets.

10. The apparatus of claim 9, wherein the buffer resource information of the last node is determined on the basis of a buffer size allocated to the service and attributes of the service.

11. The apparatus of claim 9, wherein the control part is configured to, in order to perform control so that the nodes transmit the packet on the basis of the local latency budgets, set clear upper and lower bounds of the local latency budget that each of the nodes needs to guarantee.

12. The apparatus of claim 11, wherein the control part is configured to, in order to perform control so that the nodes transmit the packet on the basis of the local latency budgets,
collect the buffer resource information of all the nodes; and
calculate the local latency budget of each of the nodes that does not exceed latency time providable on the basis of a buffer resource of each node.

13. The apparatus of claim 12, wherein the local latency budgets are determined on the basis of total network latency and residual latency time obtained by subtracting latency guaranteeable by the last node so that a service latency requirement is guaranteed.

14. The apparatus of claim 9, wherein the control part is configured to, in order for the last node to guarantee the residual latency budget finally,
forward, to the last node, actual latency information consumed by each of the nodes when the nodes transmit the packet within upper bounds and lower bounds of the local latency budgets;
identify the residual latency budget on the basis of the actual latency information forwarded from the previous nodes; and
set the identified residual latency budget as a local latency budget of the last node.

15. The apparatus of claim 14, wherein when an upper bound of the residual latency is greater than maximum latency providable on the basis of a buffer resource of the last node, it is determined that an upper bound of the local latency budget of the last node is the maximum latency providable by the last node.

16. The apparatus of claim 10, wherein the attributes of the service include information on a packet forwarding period, the number of packets forwarded within the period, and a packet size.

17. An SDN controller for time-deterministic packet forwarding that guarantees a maximum and minimum latency requirement of a service, the SDN controller comprising:
a transceiver; and
a control part operably connected to the transceiver,
wherein the control part is configured to
receive latency information of links and nodes on a path, and buffer resource information of the nodes;
calculate, on the basis of the buffer resource information of the last node, local latency budgets that the other nodes need to guarantee;
perform control so that the nodes transmit a packet on the basis of the local latency budgets; and
perform control so that finally, the last node guarantees a residual latency budget remaining after the nodes transmit the packet within the local latency budgets.

18. The SDN controller of claim 17, wherein the buffer resource information of the last node is determined on the basis of a buffer size allocated to the service and attributes of the service.

19. The SDN controller of claim 17, wherein the control part is configured to, in order to perform control so that the nodes transmit the packet on the basis of the local latency budgets, set clear upper and lower bounds of the local latency budget that each of the nodes needs to guarantee.
